(19) United States
(12) Patent Application Publication
(10) Pub. No.: US 2026/0339680 A1
(43) Pub. Date: Oct. 29, 2026

(54) DECENTRALIZED ASSET DISPOSITIONING TOOL

(71) Applicant: Wells Fargo Bank, N. A., San Francisco, CA (US)

(72) Inventors: Aaron L. Johnson, Charlotte, NC (US); Benjamin S. Taylor, Williston, VT (US); Mia Karin Eriksson, Charlotte, NC (US); Tambra Nichols, Charlotte, NC (US); Brian M. McMillen, Davidson, NC (US); Carrie Anne Hanson, Charlotte, NC (US)

(21) Appl. No.: 18/045,323

(22) Filed: Oct. 10, 2022

(51) Int. Cl. G06F 9/451; G06Q 50/18

(52) U.S. Cl. CPC G06F 9/451; G06Q 50/186

(57) ABSTRACT

Various examples are directed to computer-implemented systems and methods for providing a decentralized asset dispositioning tool. A method includes receiving information related to assets of a user, and automatically identifying non-allocated assets of the user based on the information. Candidate beneficiaries are automatically identified for the non-allocated assets of the user, and user prompts are generated based on the information related to non-allocated assets and the candidate beneficiaries. Transaction history of the user is determined based on the received information, and the generated user prompts are prioritized based on the determined user transaction history. The prioritized user prompts are displayed on a graphical user interface (GUI) of a device of the user.

### TECHNICAL FIELD

This document relates generally to computer systems and more particularly to systems and methods for a decentralized asset dispositioning tool.

### BACKGROUND

Estate planning can be a daunting, complex, and time-consuming process for many individuals, and thus may deter individuals from seeking to proactively plan. However, a lack of estate planning may have adverse consequences for intended beneficiaries. Furthermore, individuals without a will may already know particular beneficiaries for whom they would like to receive various portions of their assets, but have never explicitly formalized those intentions. There is a need for improved systems and methods of preparing for individual asset division.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a method for providing a decentralized asset dispositioning tool;

FIG. 1B illustrates an example embodiment of a method for preparing for individual asset division using a decentralized asset dispositioning tool;

FIG. 2 illustrates an exemplary infrastructure for use in the present subject matter;

FIG. 3 illustrates an example machine learning module for a decentralized asset dispositioning tool, according to various embodiments;

FIG. 4 illustrates a flowchart of a method of training a model to prepare for individual asset division using a decentralized asset dispositioning tool, according to various embodiments;

FIG. 5 illustrates a graphical diagram of an example database engine used to identify transactions to trigger a decentralized asset dispositioning tool, according to various embodiments;

FIGS. 6A-6B illustrate example screenshots of a decentralized asset dispositioning tool showing user prompts for an identified non-allocated asset, according to various embodiments;

FIGS. 7A-7B illustrate example screenshots of a decentralized asset dispositioning tool showing features of user prompts for an identified non-allocated asset, according to various embodiments;

FIG. 8 illustrates an example screenshot of a decentralized asset dispositioning tool showing a summary of assets for a beneficiary of a user, according to various embodiments;

FIGS. 9A-9B illustrate example screenshots of a decentralized asset dispositioning tool showing an interactive dashboard for a user, according to various embodiments; and

FIG. 10 is a block diagram of a machine in the example form of a computer system within which a set of instructions may be executed, for causing the machine to perform any one or more of the methodologies discussed herein.

### DETAILED DESCRIPTION

For many individuals or users, estate planning can be a daunting process and thus may deter individuals from seeking to proactively plan. However, a lack of estate planning may have adverse consequences for intended beneficiaries. Furthermore, individuals without a will may already know particular beneficiaries for whom they would like to receive various portions of their assets, but have never explicitly formalized those intentions.

The present subject matter provides a decentralized asset dispositioning tool or system that enables users upon prompting to begin to prepare for division of assets. Various embodiments of the system may collect user input related to the allocation of associated assets in via generated prompts.

Various examples include a prompt generation engine to prompt a user for information about assets and beneficiary identification for known user assets, in various embodiments. A priority prompt may be sent to a user if a triggering event is identified by the tool, such as the purchase of a house by the user. A dispositioning tool may be provided that packages prompts together and pushes the prompts to the user, in various embodiments. The present system may log the user responses to the prompts in a user-specific database, and use the responses to generate a depiction of the user's assets and specified beneficiaries such as a “pre-will” type document, in various embodiments.

The asset dispositioning system may operate to collect user data regarding the allocation of an individual's assets using a prompt generation engine, in various examples. According to various embodiments, the prompt generation engine may be configured to generate prompts to the user based on currently non-allocated assets associated with the user and provide the prompts such as through an app on a user device. The prompt generation engine may also receive an indication of beneficiary candidates via user input or response to a prompt and/or from analysis of a user profile. The prompt generation engine may also analyze historical user transactions and/or user data to determine the beneficiary candidates, in various embodiments.

According to various embodiments, the generated prompts may accept user input and may be represented in a simplistic visual manner. In various examples, a user may be presented with a question on a graphical user interface (GUI) or display on a user device, and be provided a number of response options, thereby narrowing down potential choices presented to the user. For example, a user may be presented with the question, “who should receive your boat?” and may provide response options of candidate beneficiary A and candidate beneficiary B. In this example, the user may select one of the response options, such as by swiping left or right, to select their preferred beneficiary. Other numbers of response options and other types of user input may be used without departing from the scope of the present subject matter. In various embodiments, user interactions such as responses to prompts may be logged and stored in the system such as in a user-specific database, a cloud storage location, or other memory device. The present subject matter refers to “user device” or “device of a user” as any device used or viewed by the user, regardless of ownership or location of said device.

In various embodiments, transaction history of the user may drive the prompt generation engine to generate particular prompts and further, the prompt generation engine may flag particular prompts as a priority prompt. For example, if a user recently bought a house, the prompt generation engine may generate prompts related to the house and may flag the prompt such that it is prioritized to be pushed to the user device in the next prompt package.

A dispositioning tool may package one or more prompts together and push the prompt package to a user device, in various embodiments. The dispositioning tool may be configured to only include a prompt count below a threshold number of prompts to avoid user frustration, in some embodiments.

In various embodiments, user responses may be stored within the system and can be used to generate a “pre-will” that can thereafter be quickly formalized into a real will.

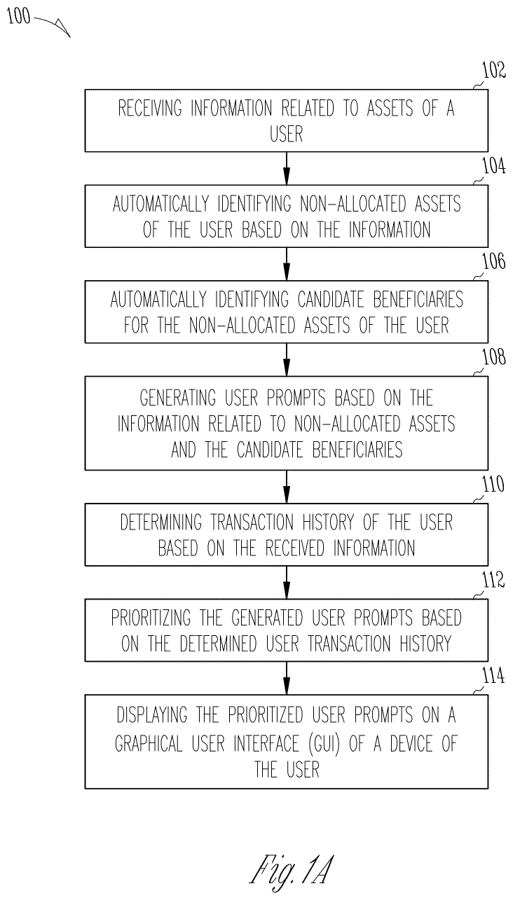

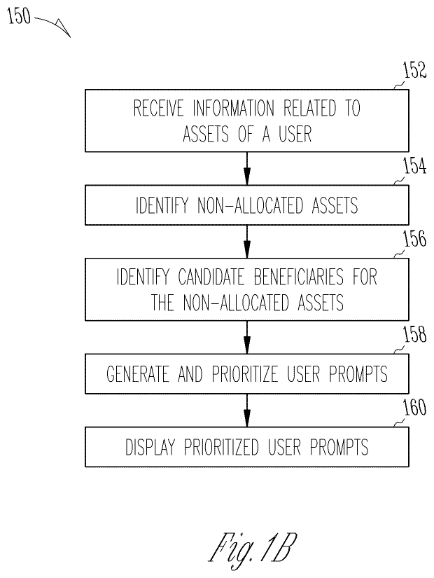

FIG. 1A illustrates an example embodiment of a method for providing a decentralized asset dispositioning tool. The method 100 includes receiving information related to assets of a user at step 102, and automatically identifying non-allocated assets of the user based on the information at step 104. Candidate beneficiaries are automatically identified for the non-allocated assets of the user at step 106, and user prompts are generated based on the information related to non-allocated assets and the candidate beneficiaries at step 108. Transaction history of the user is determined based on the received information at step 110, and the generated user prompts are prioritized based on the determined user transaction history at step 112. The prioritized user prompts are displayed on a graphical user interface (GUI) of a device of the user at step 114.

In some examples, receiving information (step 102) may include searching a database, obtaining information via an online query, or obtaining input from a computer interface. Transaction data may be mined or searched, such as data available through checking or lending accounts, in various embodiments. Data may be obtained or received in various manners, whether internally or externally, without departing from the scope of the present subject matter. In various examples, automatically identifying non-allocated assets (step 104) may include using a filter or search of a data stream or database, using machine learning or artificial intelligence, or other types of identification processes. In some examples, automatically identifying candidate beneficiaries (step 106) may include using a filter or search of a data stream or database, using machine learning or artificial intelligence, or other types of identification processes. The user may enter the beneficiary information, in various examples. In some embodiments, beneficiaries may be identified by examining joint accounts, linked accounts, or household data of the user. In various embodiments, a beneficiary library or user-specific database may be created by the system and used to pre-populate a section of a display with beneficiaries for selection by the user.

In various embodiments, the present system may interface with an aggregator for up-to-date net worth calculations, and data from the aggregator may be obtained (with user consent) to identify assets and beneficiaries, The present system may be used with or interface with any number of other systems, either in or out of a network of common ownership, to obtain data. Public databases or resources may also be mined or searched by the present system to identify assets or liabilities of the user, in various examples.

In some examples, generating user prompts (step 108) may include providing a script for obtaining input from the user based on the received information, including but not limited to generating questions, statements, or yes/no type inquiries that can be used in a swipe left or swipe right response scenario by the user. In various examples, determining a transaction history (step 110) may include using a filter or search of a data stream or database, using machine learning or artificial intelligence, or other types of identification processes.

In some examples, prioritizing user prompts (step 112) may include running an algorithm using a processor to determine priority of prompts based on one or more factors, such as value of non-allocated assets or recency of acquisition of such assets. In various examples, displaying prioritized prompts (step 114) may include providing a display, or portion of a display on a GUI of the user with prompts that provide a user with ability to make inputs or selections to obtain a user's preference regarding assets and beneficiaries. The display may include a specialized interactive portion that can remain highlighted on a screen of the GUI, in some examples. The prompts may include areas to accept textual, graphical or other types of input from the user. Other examples of performing the steps of the method can be used without departing from the scope of the present subject matter.

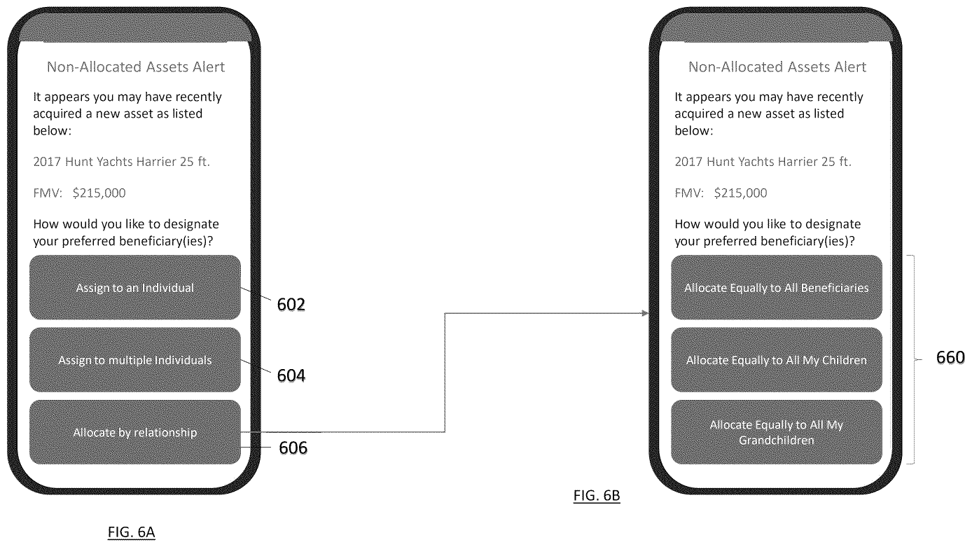

In various examples, the method may further include receiving user input in response to the prioritized user prompts. The method may further include storing data representative of the non-allocated assets, the candidate beneficiaries, the transaction history, and the user input in a user-specific database, in various examples. In some examples, the method may further include generating a graphical representation of potential asset distribution of the non-allocated assets based on the stored data. Various examples of graphical representations are provided in FIGS. 6A-9B, as described below. Other graphical representations may be used without departing from the scope of the present subject matter. In various embodiments, prioritizing the generated user prompts (step 112) may include packaging two or more prompts together based on the determined user transaction history. The method may further include sending the packaged prompts to the device of the user, in various embodiments. According to various embodiments, the method may further include limiting a number of packaged prompts to a programmable threshold number of prompts.

FIG. 1B illustrates an example embodiment of a method for preparing for individual asset division using a decentralized asset dispositioning tool. Information related to assets of a user is received at step 152, and non-allocated assets of the user are identified at step 154. At step 156, candidate beneficiaries are identified for the non-allocated assets, such as by using AI and/or specified by the user. User prompts are generated and prioritized at step 158, and the user prompts are displayed at step 160, such as on a user device.

In some examples, receiving information (step 152) may include searching a database, obtaining information via an online query, or obtaining input from a computer interface. In various examples, identifying non-allocated assets (step 154) may include using a filter or search of a data stream or database, receiving input from the user, using machine learning or artificial intelligence, or other types of identification processes. In some examples, identifying candidate beneficiaries (step 156) may include using a filter or search of a data stream or database, receiving input from the user, using machine learning or artificial intelligence, or other types of identification processes. In some examples, generating and prioritizing user prompts (step 158) may include providing a script for obtaining input from the user based on the received information, including but not limited to generating questions, statements, or yes/no type inquiries that can be used in a swipe left or swipe right response scenario by the user. Step 158 may also include running an algorithm using a processor to determine priority of prompts based on one or more factors, such as value of non-allocated assets or recency of acquisition of such assets.

In various examples, displaying prioritized prompts (step 160) may include providing a display, or portion of a display on a GUI of the user with prompts that provide a user with ability to make inputs or selections to obtain a user's preference regarding assets and beneficiaries. The display may include a specialized interactive portion that can remain highlighted on a screen of the GUI, in some examples. The prompts may include areas to accept textual, graphical or other types of input from the user. Other examples of performing the steps of the method can be used without departing from the scope of the present subject matter.

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1A-1B. In various examples, the non-allocated assets of the user include one or more of a financial account, a personal item, real estate, an insurance policy or a membership. Other non-allocated assets may be identified without departing from the scope of the present subject matter. In some examples, the user prompts include a request for a user to select a beneficiary from a list of the candidate beneficiaries for one or more of the non-allocated assets. In some examples, the user prompts include a chat-bot type interface. Other types of user prompts may be used without departing from the scope of the present subject matter. In various examples, the transaction history of the user includes one or more of a purchase, a sale, a withdrawal, a deposit, an account opening or an account closing. Other types of user transaction history may be used without departing from the scope of the present subject matter. In various examples, the device of the user includes one or more of a laptop computer, a personal computer, a tablet, or a smart phone. Other types of user devices may be used without departing from the scope of the present subject matter.

Various embodiments include a non-transitory computer-readable storage medium, the non-transitory computer-readable storage medium including instructions that, when executed by computers, cause the computers to perform operations including the methods of FIGS. 1A-1B. In various examples, automatically identifying non-allocated assets of the user includes using artificial intelligence (AI) to identify the non-allocated assets based on the information. In various examples, automatically identifying candidate beneficiaries for the non-allocated assets of the user includes using AI to identify the candidate beneficiaries.

Users may add assets or remove assets to the system using the disposition tool, with or without the generated prompts. In some examples, if the user obtains new asset, the application may prompt the user to select a beneficiary for the new asset. The present system enables maintaining of an estate plan over time and accelerates process of will drafting by preparing a pre-will type document.

The tool may be decentralized in that it operates across different entities or different accounts for a user. For example, the application may search for other accounts of a user to add to the database for the tool. In some examples, the tool may include a chat-bot type interface to request or obtain information about a user's assets. In some examples, a beneficiary of a user may have limited access to the tool.

In various examples, the tool includes an artificial intelligence (AI) or machine learning component that assists in identifying user assets for including in the database. In one example, if the user has an online membership in a boat owner group, the tool may identify a boat of a user for inclusion as an asset of the user in the database. In another example, if the user has a golf club membership, the membership itself may be considered as an asset of the user. The tool may also be used to track non-financial assets of the user, in various embodiments. For example, photos, personal items, and other assets may be identified by the tool (such as upon purchase, acquisition, or other method) and added to the database of the user. In some examples, events such as the sale of an asset or closing of an account by the user may trigger the tool to remove the asset or account from the user-specific database.

In various examples, life insurance of a user may be identified by the tool and added to the user asset database. In some examples, the tool may prompt the user for information regarding insurance policies.

In various embodiments, a loan by a user to a beneficiary may be identified by the tool and tracked to adjust of an amount of a subsequent bequest to the beneficiary.

In various examples, if the tool is notified of the death of the user, the tool may provide a visual depiction of a family tree and/or beneficiary group with icons or photos showing which beneficiaries are identified for respective assets of the user. In some examples, a summary may include what the user contemplates giving to various beneficiaries or charities. In the case of the family tree, a subtotal may be provided for monetary value for each branch of the tree, in various embodiments.

In various examples, the tool may be an application that resides on a personal computing device of a user. In various embodiments, the tool may reside on a server. In some embodiments, the tool may reside partially on a personal computing device and partially on a server. According to various embodiments, the tool captures data, stores it in a database remotely and/or locally, and refreshes it periodically, or when an asset is identified, or when a user logs in to the tool, or a combination thereof.

In various examples, the tool may store information regarding the user, such as assets and corresponding identified beneficiaries of the assets, in a blockchain format or ledger. This storage technique may provide for an intractable record of the history of the assets of the user.

In various embodiments, various individuals may have access to the tool to obtain information about the user's assets and designated beneficiaries. In various examples, individuals may be assigned different levels of access by the user, by the tool, by an administrator, or by some combination thereof. For example, the user may have the greatest level of access, followed by a financial advisor of the user, followed by a beneficiary of the user, etc. Other levels of access may be used without departing from the scope of the present subject matter. A tax professional or attorney selected by the user may be granted access to the tool, in an embodiment. Access to the tool may be provided at multiple locations, in various embodiments. Different rolls may be assigned to various individuals by the tool, in an embodiment. Different layers of access may be provided to various individuals by the too, in an embodiment.

In various embodiments, various events may trigger updates to the database of a user by the tool. In one example, the addition of an asset by a user may trigger an update of the user database. Other examples of triggers include, but are not limited to, change of address of the user, addition of a beneficiary by the user, death of a user, death of a beneficiary and opening an account by the user.

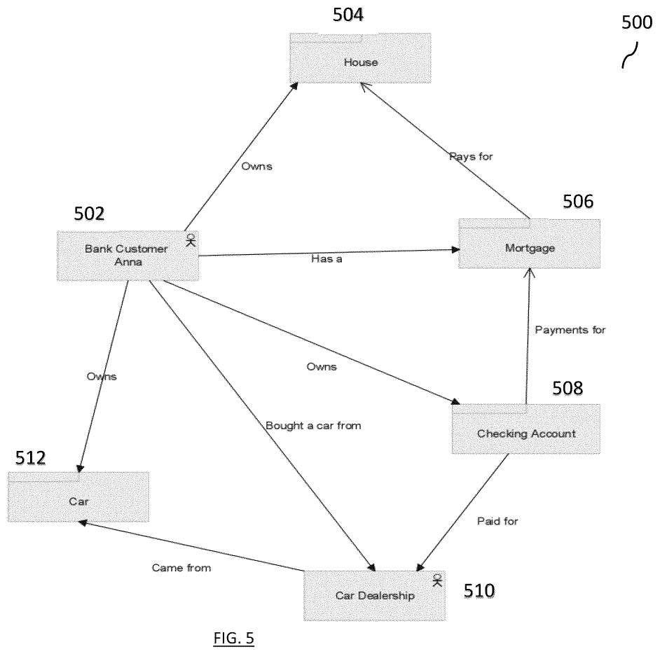

Various events may be identified by the tool as triggering updates. In one example, events or items passively recognized by the tool may trigger an update or a notification/request for information from the user. In one example, the paying of a life insurance premium by the user triggers an update. In another example, the purchase of diapers by the user triggers an update. In various examples, the system (or tool) itself may trigger the update based on an event such as an account of the user reaching a zero balance. In some examples, a speeding ticket of a user may trigger an update. In some examples, a divorce or other life event of a user may be identified by the tool and trigger an update. The AI portion of the tool may search available databases for mentions of the user or beneficiaries to identify triggering events, for example as shown in FIG. 5 described below, in various embodiments. Non-traditional sources of data of the user may be searched by the tool, such as credit bureaus, other user accounts, and the like. In various examples, the dispositioning tool may obtain values (such as market values) of non-allocated assets from external websites or databases, such as real estate or blue book type websites. Other websites or databases may be accessed to enrich data collection without departing from the scope of the present subject matter.

In various examples, the tool uses information about the user such as birthdate, address, health events, etc. to trigger an update. In some examples, the tool performs an annual review to update the user database. Other periodic updates may be performed without departing from the scope of the present subject matter.

In various embodiments, third party providers, such as tax accountants or the like, may be rated and/or recommended by the tool. In some examples, a user can review or rate a third party provider, the reviews and ratings may be aggregated by the tool, and other users of the tool may view the reviews and ratings to select a third party provider. In some examples, the tool may recommend a third party provider to a user based on the reviews and ratings. In various examples, a third party provider may have to pay a fee to be included in the recommendations portion of the tool.

In various examples, the tool produces a “pre-will” type document that can be easily formalized into a legal will of the user, using the database of user assets and identified beneficiaries accumulated by the tool. The tool may ease the burden on an executor or trustee with respect to identifying user assets and beneficiary designations for the identified assets, in various embodiments. According to various embodiments, the tool may provide a register of beneficiaries to enable the beneficiaries to obtain the designated assets more quickly upon death of the user.

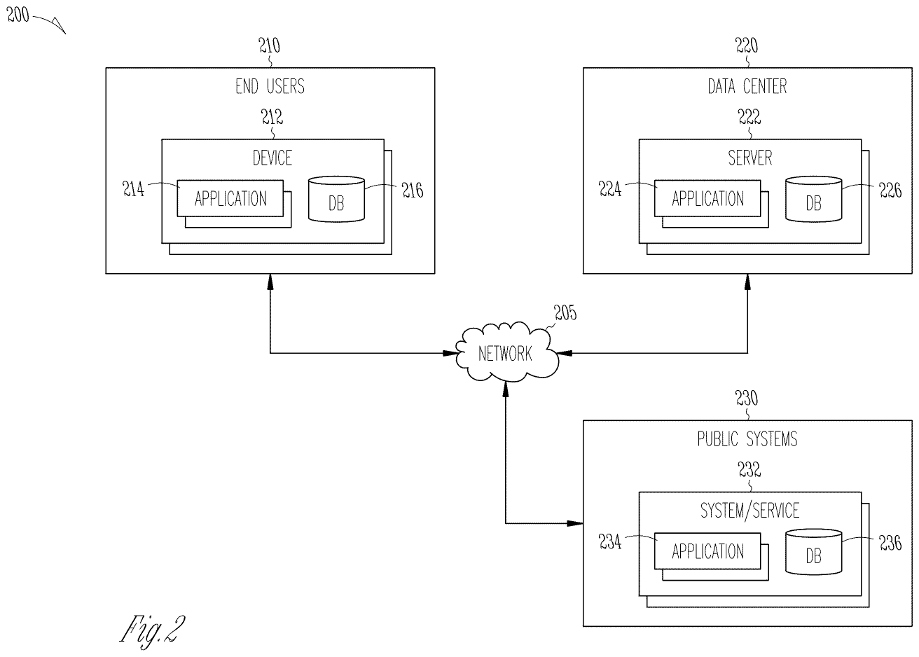

FIG. 2 illustrates an exemplary infrastructure for providing a system of the present subject matter. The infrastructure may comprise a distributed system 200 that may include a client-server architecture or cloud computing system. Distributed system 200 may have one or more end users 210. An end user 210 may have various computing devices 212, which may be a machine 800 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The business entity may be a computer service provider, as may be the case for a cloud services provider, or it may be a consumer product or service provider, such as a retailer. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 800.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 800.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222. In some examples the servers 222 are used to receive information related to assets of a user, identify non-allocated assets of the user, identify candidate beneficiaries for the non-allocated assets, generate and prioritize user prompts, and send the prompts to a display, such as on a user device. The system 200 may be used to execute the steps of the methods of FIGS. 1A-1B, in various embodiments.

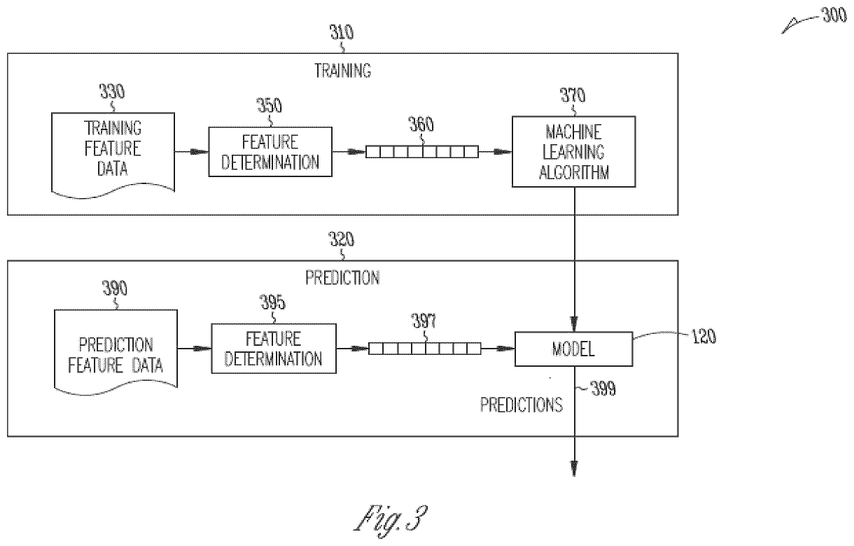

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of identifying a non-allocated asset or a candidate beneficiary of a non-allocated asset. Categories of training feature data may include transaction history over a past time period (e.g., 12 months); expenditure details; individual financial history; whether the user experienced a life event within a past time period (e.g., 12 months); and the like. In some examples, the financial history of the user may only utilize financial history of the account that is created by the user, but in other examples, other account history of other accounts (e.g., checking, savings, and the like) may also be used. For example, a history of deposits into a checking or savings account may be used.

Specific training feature data and prediction feature data 390 may include, for example one or more of: identified assets of the user, personal financial history of the user; number of life events in a past time period; a number of months since an account was funded; and the like.

Feature determination module 350 selects training vector 360 from the training feature data 330. The selected data may fill training vector 360 and comprises a set of the training feature data that is determined to be predictive of non-allocated assets or candidate beneficiaries. In some examples, the tasks performed by the feature determination module 350 may be performed by the machine learning algorithm 370 as part of the learning process. Feature determination module 350 may remove one or more features that are not predictive of non-allocated assets or candidate beneficiaries prior to training the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as assets or beneficiaries. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. In various examples the predictions 399 include identifying non-allocated assts of the user. In further examples the predictions 399 include identifying candidate beneficiaries for the non-allocated assets. Other types of predictions 399 may be used without departing from the scope of the present subject matter.

For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

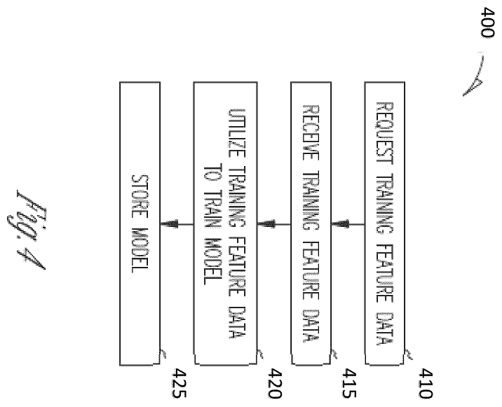

FIG. 4 illustrates a flowchart of a method 400 of training a model to prepare for individual asset division using a decentralized asset dispositioning tool, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions.

FIG. 5 illustrates a graphical diagram of an example database engine used to identify transactions to trigger a decentralized asset dispositioning tool, according to various embodiments. In various embodiments, the AI engine is enabled by a graph database, such as the graph database 500 shown in FIG. 5, which may be used to facilitate identification of transactions which trigger responses by the system. In the depicted example, the graph database 500 illustrates a user 502 that has a checking account 508 used to pay a mortgage 506 on a house 504, and the checking account 508 is further used to make payments to a car dealership 510 for the purchase of a car 512. All associated databases depicted may be used to facilitate identification of transactions which trigger responses by the system. Other types of data sources may be used without departing from the scope of the present subject matter.

FIGS. 6A-6B illustrate screenshots of a decentralized asset dispositioning tool showing user prompts for an identified non-allocated asset, according to various embodiments. While the graphical diagrams provided are representative of interfaces provided on a screen of a user device, other interfaces may be used without departing from the scope of the present subject matter.

In FIG. 6A, a user receives a prompt upon recognition that the user may have secured a new asset (e.g., a yacht) and the prompt may use existing beneficiary data to help the user assign beneficiaries to the asset. In the depicted embodiment, the system identifies the non-allocated asset, provides a fair market value (FMV) for the asset, and prompts the user to designate a beneficiary or beneficiaries for the asset. In this example, three selectable options are provided: to “assign to an individual” 602, “assign to multiple individuals” 604, or “allocate by relationship” 606. In various embodiments, upon user selection of an option, a drop down or expanded list is provided. For example, if the user selects “allocate by relationship” 606, additional options 660 are provided such as “allocate equally to all beneficiaries”, “allocate equally to all children of user”, or “allocate equally to all grandchildren of user”, as shown in FIG. 6B. The additional options 660 are dynamically provided and depend on known beneficiary options and the beneficiary's relationship to the user, in various embodiments.

In some examples, if a user selects “assign to an individual” 602, a drop down list of existing beneficiaries is provided for the user to select one, and/or a user may be prompted to add a new beneficiary. In some examples, if a user selects “assign to multiple individuals” 604, a drop down list of existing beneficiaries is provided for the user to select more than one, and/or a user may be prompted to add one or more new beneficiaries. In various examples, the system may prompt the user to assign specific percentages to specific beneficiaries. In some examples, a warning is provided to the user by the system to revisit asset assignment if a potential beneficiary was added to a relationship class (i.e., children, grandchildren, etc.).

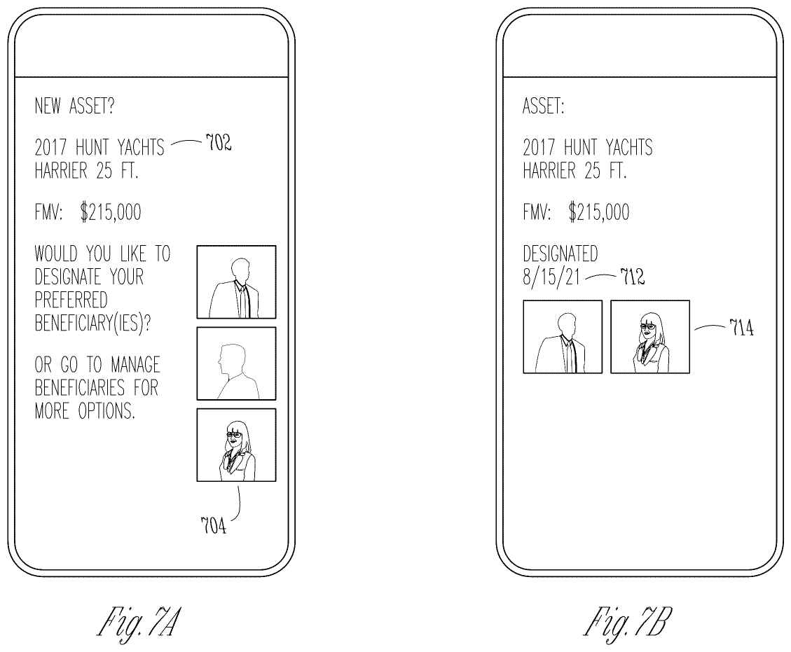

FIGS. 7A-7B illustrate screenshots of a decentralized asset dispositioning tool showing features of user prompts for an identified non-allocated asset, according to various embodiments. In one aspect of the system, the user is prompted to “drag and drop” a depiction of the asset 702 to the beneficiary or to “drag and drop” a depiction of the beneficiary 704 to the asset, as shown in FIG. 7A. In one example, the depiction of beneficiaries is on the right hand side of the display. After selection by the user, the display may provide an updated graphic showing the selected beneficiaries 714 and the date 712 of the selection or designation, as shown in FIG. 7B. In some examples, the system may automatically calculate share for each designated beneficiary of the asset based on how many were selected by the user. In various examples, the system may provide an option to default to a more complex structure or display as a “manage beneficiary” section.

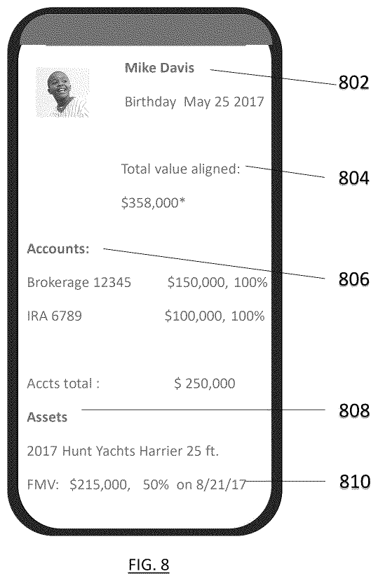

FIG. 8 illustrates a screenshot of a decentralized asset dispositioning tool showing a summary of assets for a beneficiary of a user, according to various embodiments. In this embodiment, a beneficiary detail page on a display identifies the specific beneficiary 802, and summarizes assets with the beneficiary to show what has been designated to the specific beneficiary 802. A beneficiary may have access to the beneficiary detail page, or in other embodiments only the user has access to the beneficiary detail page. In the depicted embodiment, the beneficiary detail page includes a total value 804 designated to the beneficiary, a list of accounts 806 designated to the beneficiary, and a list of assets 808 designated to the beneficiary. In some embodiments, a date of designation 810 of one or more of the assets or accounts is provided.

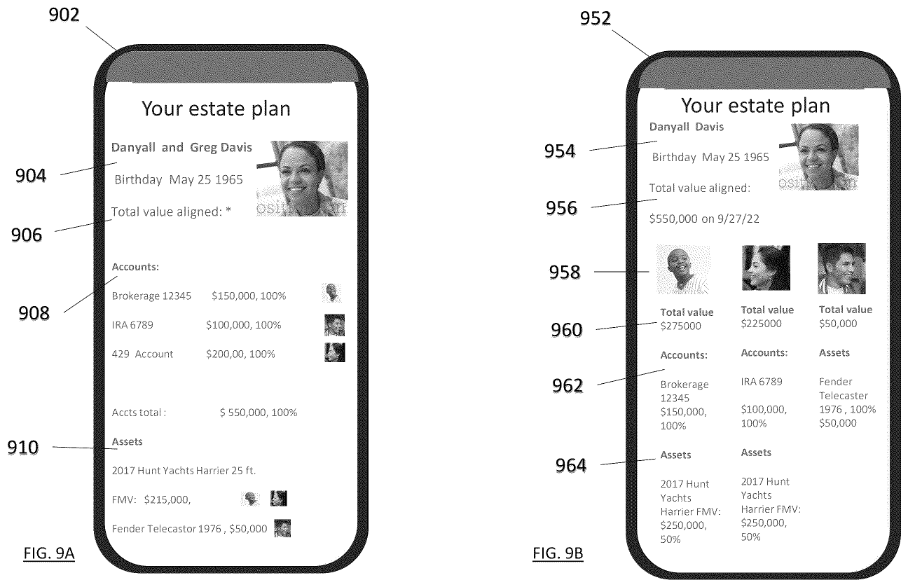

FIGS. 9A-9B illustrate screenshots of a decentralized asset dispositioning tool showing an interactive dashboard for a user, according to various embodiments. In FIG. 9A, the display provides a user's interactive dashboard 902 including identification information 904 of the user, a total value 906 of assets and accounts designated (or aligned) to beneficiaries, a summary of accounts 908, and a summary of assets 910. In various embodiments, the dashboard 902 may provide for “drag and drop” assets to beneficiary or beneficiary to assets. The dashboard 902 may also provide the distribution plan to date, and may include a timestamps of changes, in some examples. In various examples, the dashboard 902 may show percentages of assets (including accounts and other assets) allocated and a list of unallocated assets. The dashboard 902 may provide for a user to add assets, add beneficiaries, and redistribute (manually or automatically) allocations, in various embodiments.

In FIG. 9B, the display provides a beneficiary-level interactive dashboard 952 including identification information 954 of the user and a total value 956 of assets and accounts designated (or aligned) to beneficiaries. The dashboard 952 may also include an individual value 960 of assets and accounts for each beneficiary 958, a summary of accounts 962 designated to the beneficiary 958, and a summary of assets 964 designated to the beneficiary 958. In various embodiments, the beneficiary-level dashboard 952 provides for a user to move assets from one beneficiary to another (reallocation), and automatically re-totals the distributions upon reallocation. In some embodiments, the dashboard 952 displays non-allocated assets for user selection and distribution.

In various embodiments, a summary of beneficiary designations or allocations may be presented on the interactive dashboard on a display of a user device. The summary may include a total of the estate of the user, with an interactive portion that allows the user to make changes, and a date change capture feature to provide dates for any changes entered by the user. The summary may be presented with sections corresponding to an asset/account type and/or beneficiary-specific sections, in various embodiments. In various examples, the present system may provide the ability to re-allocate or re-designate beneficiaries using an interactive dashboard, allowing a user to remove a beneficiary such as based on death, divorce or disfavor of a beneficiary, or to add a beneficiary based on birth, adoption or marriage. The system may provide for automatic redistribution of assets upon adding or removing a beneficiary based on any of these factors, thus providing a dynamic and up-to-date estate plan for the user, in various examples.

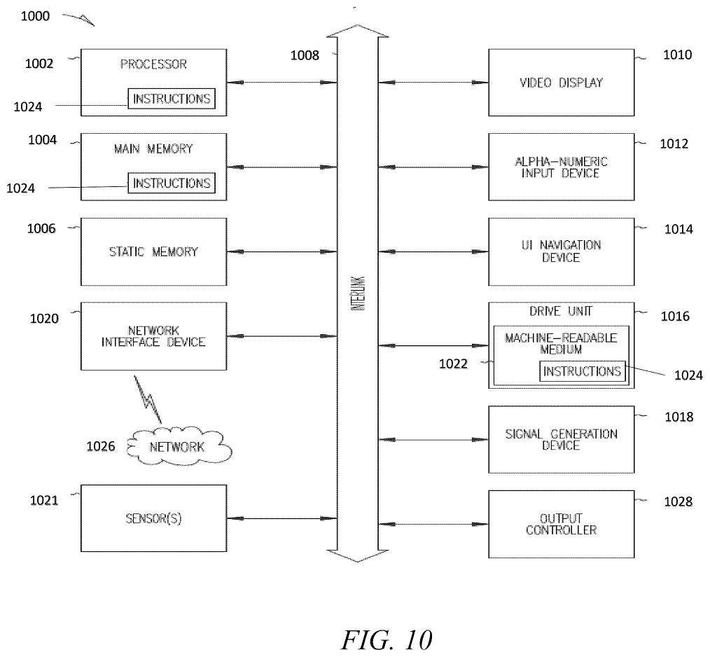

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may implement one or more of the training and prediction modules 310, 320 (e.g., as software or dedicated hardware) and may be configured to perform the methods of FIGS. 1A, 1B and 4. The machine 1000 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 1024 may further be transmitted or received over a communications network 1026 using a transmission medium via the network interface device 1020. The Machine 1000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques.

### Other Notes and Examples

Example 1 is a computer-implemented method including: receiving, by a computer system, information related to assets of a user; automatically identifying, by the computer system, non-allocated assets of the user based on the information; automatically identifying, by the computer system, candidate beneficiaries for the non-allocated assets of the user; generating, by the computer system, user prompts based on the information related to non-allocated assets and the candidate beneficiaries; determining, by the computer system, transaction history of the user based on the received information; prioritizing, by the computer system, the generated user prompts based on the determined user transaction history; and displaying, by the computer system, the prioritized user prompts on a graphical user interface (GUI) of a device of the user.

In Example 2, the subject matter of Example 1 optionally further includes receiving, by the computer system, user input in response to the prioritized user prompts.

In Example 3, the subject matter of Example 2 optionally further includes storing, by the computer system, data representative of the non-allocated assets, the candidate beneficiaries, the transaction history, and the user input in a user-specific database.

In Example 4, the subject matter of Example 3 optionally further includes generating, by the computer system, a graphical representation of potential asset distribution of the non-allocated assets based on the stored data.

In Example 5, the subject matter of Example 1 optionally includes wherein prioritizing the generated user prompts includes: packaging, by the computer system, two or more prompts together based on the determined user transaction history.

In Example 6, the subject matter of Example 5 optionally further includes sending, by the computer system, the packaged prompts to the device of the user.

In Example 7, the subject matter of Example 5 optionally further includes limiting, by the computer system, a number of packaged prompts to a programmable threshold number of prompts.

Example 8 is a system including: a computing system comprising one or more processors and a data storage system in communication with the one or more processors, wherein the data storage system comprises instructions thereon that, when executed by the one or more processors, causes the one or more processors to: receive information related to assets of a user; automatically identify non-allocated assets of the user based on the information; automatically identify candidate beneficiaries for the non-allocated assets of the user; generate user prompts based on the information related to non-allocated assets and the candidate beneficiaries; determine transaction history of the user based on the received information; prioritize the generated user prompts based on the determined user transaction history; and display the prioritized user prompts on a graphical user interface (GUI) of a device of the user.

In Example 9, the subject matter of Example 8 optionally includes wherein the non-allocated assets of the user include one or more of a financial account, a personal item, real estate, an insurance policy, or a membership.

In Example 10, the subject matter of Example 8 optionally includes wherein the user prompts include a request for a user to select a beneficiary from a list of the candidate beneficiaries for one or more of the non-allocated assets.

In Example 11, the subject matter of Example 8 optionally includes wherein the user prompts include a chat-bot type interface.

In Example 12, the subject matter of Example 8 optionally includes wherein the transaction history of the user includes one or more of a purchase, a sale, a withdrawal, a deposit, an account opening or an account closing.

In Example 13, the subject matter of Example 8 optionally includes wherein the device of the user includes one or more of a laptop computer, a personal computer, a tablet, or a smart phone.

Example 14 is a non-transitory computer-readable storage medium, the non-transitory computer-readable storage medium including instructions that, when executed by computers, cause the computers to perform operations of: receiving information related to assets of a user; automatically identifying non-allocated assets of the user based on the information; automatically identifying candidate beneficiaries for the non-allocated assets of the user; generating user prompts based on the information related to non-allocated assets and the candidate beneficiaries; determining transaction history of the user based on the received information; prioritizing the generated user prompts based on the determined user transaction history; and displaying the prioritized user prompts on a graphical user interface (GUI) of a device of the user.

In Example 15, the subject matter of Example 14 optionally includes wherein the non-transitory computer-readable storage medium further includes instructions that, when executed by computers, cause the computers to perform operations of: receiving user input in response to the prioritized user prompts.

In Example 16, the subject matter of Example 14 optionally includes wherein the non-transitory computer-readable storage medium further includes instructions that, when executed by computers, cause the computers to perform operations of: storing data representative of the non-allocated assets, the candidate beneficiaries, the transaction history, and the user input in a user-specific database.

In Example 17, the subject matter of Example 16 optionally includes wherein the non-transitory computer-readable storage medium further includes instructions that, when executed by computers, cause the computers to perform operations of: generating a graphical representation of potential asset distribution of the non-allocated assets based on the stored data.

In Example 18, the subject matter of Example 14 optionally includes wherein the non-transitory computer-readable storage medium further includes instructions that, when executed by computers, cause the computers to perform operations of: packaging two or more prompts together based on the determined user transaction history.

In Example 19, the subject matter of Example 18 optionally includes wherein automatically identifying non-allocated assets of the user includes using artificial intelligence (AI) to identify the non-allocated assets based on the information.

In Example 20, the subject matter of Example 18 optionally includes wherein automatically identifying candidate beneficiaries for the non-allocated assets of the user includes using AI to identify the candidate beneficiaries

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a computer system, information related to assets of a user;
automatically identifying, by the computer system, non-allocated assets of the user based on the information;
automatically identifying, by the computer system, candidate beneficiaries for the non-allocated assets of the user;
generating, by the computer system, user prompts based on the information related to non-allocated assets and the candidate beneficiaries;
determining, by the computer system, transaction history of the user based on the received information, wherein the transaction history includes online membership data and account activity used to identify the non-allocated assets;
prioritizing, by the computer system, the generated user prompts based on the determined user transaction history, wherein the prioritizing includes using an artificial intelligence component to correlate the identified non-allocated assets with the candidate beneficiaries based on the transaction history, wherein the artificial intelligence component comprises a machine learning model that is periodically updated using a closed loop system based on user feedback from responses to the user prompts, wherein the artificial intelligence component uses a graph database that maps relationships between user accounts, transactions, and assets of the user to identify transactions that trigger the prioritizing of the generated user prompts, and displaying, by the computer system, the prioritized user prompts on a graphical user interface (GUI) of a device of the user.

2. The computer-implemented method of claim 1, further comprising:
receiving, by the computer system, user input in response to the prioritized user prompts.

3. The computer-implemented method of claim 2, further comprising:
storing, by the computer system, data representative of the non-allocated assets, the candidate beneficiaries, the transaction history, and the user input in a user-specific database.

4. The computer-implemented method of claim 3, further comprising:
generating, by the computer system, a graphical representation of potential asset distribution of the non-allocated assets based on the stored data.

5. The computer-implemented method of claim 1, wherein prioritizing the generated user prompts includes:
packaging, by the computer system, two or more prompts together based on the determined user transaction history.

6. The computer-implemented method of claim 5, further comprising:
sending, by the computer system, the packaged prompts to the device of the user.

7. The computer-implemented method of claim 5, further comprising;
limiting, by the computer system, a number of packaged prompts to a programmable threshold number of prompts.

8. A system comprising:
a computing system comprising one or more processors and a data storage system in communication with the one or more processors, wherein the data storage system comprises instructions thereon that, when executed by the one or more processors, causes the one or more processors to:
receive information related to assets of a user;
automatically identify non-allocated assets of the user based on the information;
automatically identify candidate beneficiaries for the non-allocated assets of the user;
generate user prompts based on the information related to non-allocated assets and the candidate beneficiaries;
determine transaction history of the user based on the received information, wherein the transaction history includes online membership data and account activity used to identify the non-allocated assets;
prioritize the generated user prompts based on the determined user transaction history, wherein the prioritizing includes using an artificial intelligence component to correlate the identified non-allocated assets with the candidate beneficiaries based on the transaction history, wherein the artificial intelligence component comprises a machine learning model that is periodically updated using a closed loop system based on user feedback from responses to the user prompts, wherein the artificial intelligence component uses a graph database that maps relationships between user accounts, transactions, and assets of the user to identify transactions that trigger the prioritizing of the generated user prompts; and
display the prioritized user prompts on a graphical user interface (GUI) of a device of the user.

9. The system of claim 8, wherein the non-allocated assets of the user include one or more of a financial account, a personal item, real estate, an insurance policy or a membership.

10. The system of claim 8, wherein the user prompts include a request for a user to select a beneficiary from a list of the candidate beneficiaries for one or more of the non-allocated assets.

11. The system of claim 8, wherein the user prompts include a chat-bot type interface.

12. The system of claim 8, wherein the transaction history of the user includes one or more of a purchase, a sale, a withdrawal, a deposit, an account opening or an account closing.

13. The system of claim 8, wherein the device of the user includes one or more of a laptop computer, a personal computer, a tablet, or a smart phone.

14. A non-transitory computer-readable storage medium, the non-transitory computer-readable storage medium including instructions that, when executed by computers, cause the computers to perform operations of;
receiving information related to assets of a user;
automatically identifying non-allocated assets of the user based on the information;
automatically identifying candidate beneficiaries for the non-allocated assets of the user;
generating user prompts based on the information related to non-allocated assets and the candidate beneficiaries;
determining transaction history of the user based on the received information, wherein the transaction history includes online membership data and account activity used to identify the non-allocated assets;
prioritizing the generated user prompts based on the determined user transaction history, wherein the prioritizing includes using an artificial intelligence component to correlate the identified non-allocated assets with the candidate beneficiaries based on the transaction history, wherein the artificial intelligence component comprises a machine learning model that is periodically updated using a closed loop system based on user feedback from responses to the user prompts, wherein the artificial intelligence component uses a graph database that maps relationships between user accounts, transactions, and assets of the user to identify transactions that trigger the prioritizing of the generated user prompts; and
displaying the prioritized user prompts on a graphical user interface (GUI) of a device of the user.

15. The non-transitory computer-readable storage medium of claim 14, wherein the non-transitory computer-readable storage medium further includes instructions that, when executed by computers, cause the computers to perform operations of:
receiving user input in response to the prioritized user prompts.

16. The non-transitory computer-readable storage medium of claim 15, wherein the non-transitory computer-readable storage medium further includes instructions that, when executed by computers, cause the computers to perform operations of:
storing data representative of the non-allocated assets, the candidate beneficiaries, the transaction history, and the user input in a user-specific database.

17. The non-transitory computer-readable storage medium of claim 16, wherein the non-transitory computer-readable storage medium further includes instructions that, when executed by computers, cause the computers to perform operations of:
generating a graphical representation of potential asset distribution of the non-allocated assets based on the stored data.

18. The non-transitory computer-readable storage medium of claim 14, wherein the non-transitory computer-readable storage medium further includes instructions that, when executed by computers, cause the computers to perform operations of:
packaging two or more prompts together based on the determined user transaction history.

19. The non-transitory computer-readable storage medium of claim 18, wherein automatically identifying non-allocated assets of the user includes using artificial intelligence (A) to identify the non-allocated assets based on the information.

20. The non-transitory computer-readable storage medium of claim 18, wherein automatically identifying candidate beneficiaries for the non-allocated assets of the user includes using AI to identify the candidate beneficiaries.
